(19) United States
(12) Patent Application Publication
(10) Pub. No.: US 2011/0037727 A1
(43) Pub. Date: Feb. 17, 2011

(54) TOUCH SENSOR DEVICE AND POINTING COORDINATE DETERMINATION METHOD THEREOF

(75) Inventors: Sang-Jin Lee, Yongin-si (KR); Chul-Yong Joung, Yongin-si (KR); Bang-Won Lee, Yongin-si (KR)

Correspondence Address: CANTOR COLBURN LLP, 20 Church Street, 22nd Floor, Hartford, CT, 06103, US

(73) Assignee: ATLAB INC., Yongin-si (KR)

(21) Appl. No.: 12/921,512

(22) PCT Filed: May 22, 2008
(86) PCT No.: PCT/KR2008/002872

§ 371 Date: Sep. 8, 2010

(30) Foreign Application Priority Data
Mar. 12, 2008 (KR) 10-2008-0023000

(51) Int. Cl. G06F 3/044

(52) U.S. Cl. 345/174

(57) ABSTRACT

Provided are a touch sensor device and a pointing coordinate determination method thereof. The touch sensor device includes a touch panel, a touch sensing unit that receives a touch signal, senses touch information according to a simple touch or touch strength of a touch object, and outputs an electrical signal, a touch data storage that stores touch data in response to the electrical signal, a template storage that pre-stores templates for various outlines of the touch object in response to the electrical signal, and a touch data processor that senses an outline of the touch object according to a distance difference related to the touch object by receiving the touch data, and determines pointer coordinates of a pointing device by receiving and mapping a stored template of the touch object.

### TECHNICAL FIELD

The present invention relates to a touch sensor device, and more particularly, to a touch sensor device capable of stably and variously recognizing and determining pointer coordinates and a pointing coordinate determining method thereof.

### BACKGROUND ART

As one of data input devices, a touch pad has sensing points arranged in a matrix pattern on a plane. Since the touch pad may sense a position pressed by a user and a movement direction of a contact point, it is being widely used in place of a mouse. There are various types of touch pads including a touch pad in which electrical switches are arranged on the plane or, a touch pad in which a capacitive sensor, a resistive sensor, a surface wave sensor, or an optical sensor is arranged on the plane.

To adjust the motion of a cursor in a laptop computer or the like, a touch panel configured with a plurality of touch pads using the capacitive sensor is usually used. A surface of the touch panel is covered with an insulating film, and horizontal and vertical lines are arranged at regular intervals below the insulating film. A capacitor is provided as an electrical equivalent circuit between the horizontal and vertical lines in which the horizontal lines form a first electrode and the vertical lines form a second electrode.

When a type of conductive body such as a finger is in contact with a sensing surface, an electrostatic capacitance value between touched horizontal and vertical lines is different from that between non-touched lines. For example, a variation of electrostatic capacitance of the capacitor is recognized by applying a voltage to the horizontal line and detecting a voltage induced on the vertical line, and it may be determined which portion has been touched.

In a resistive two-dimensional (2D) matrix touch panel as another type of touch panel, conductors are arranged on films of two layers and a small space is formed between the two layers that are disconnected when at rest. When a particular touch region of the touch panel is pressed with the slight force of a user's finger, the conductors between the two layers arranged in the touch region are connected to each other, such that an electrical current flows and corresponding conductor coordinates are recognized.

At this time, a binary signal is generated by recognizing only a connection of the conductors between the two layers, that is, signal on/off. Multiple binary signals are distributed around touch regions each having a finger size, thereby determining coordinates of a particular touch region.

FIG. 1 is a schematic block diagram of a touch sensor device according to the prior art, which includes a touch panel 10, a touch sensing unit 20, a touch data processor 30, and a micro control unit (MCU) 50. The touch panel 10 is configured with a plurality of touch electrodes 10-1 to 10-N and the touch data processor 30 is provided with a data comparator 32 and a pointer coordinate determinator 34.

The functions of blocks of the touch sensor device according to the prior art will be described with reference to FIG. 1.

The touch panel 10 has the plurality of touch electrodes 10-1 to 10-N in a matrix pattern on the plane, receives an input signal of a character, a number, a pattern, or the like, and generates an electrical signal from a capacitance variation.

The touch sensing unit 20 receives an electrical signal by electrically connecting a plurality of touch sensors 20-1 to 20-N to the plurality of touch electrodes 10-1 to 10-N, senses a touch point start position, a movement direction, and a movement path, and outputs an electrical signal from an electrical state variation.

The data comparator 32 receives touch data stored in a touch data storage (not shown) and computes a varied coordinate movement value by comparing currently input touch data to previously input touch data.

The pointer coordinate determinator 34 computes a position touched by a touch object from the varied coordinate movement value and determines pointer coordinates of a pointing device.

The MCU 50 computes a touch point start position, a movement direction, and a movement path of the touch object from the pointer coordinates output from the pointer coordinate determinator 34, stores computed values thereof, generates sensing data after combining the computed values to selectively stabilize data when the touch state ends, and controls the touch sensor device such that an operation indicated by an input signal applied to the touch panel 10 is performed.

An operation of the touch sensor device according to the prior art will be described with reference to FIG. 1.

For example, when a person desires to run a program by touching an icon located in a corresponding touch region of a particular position of the touch panel 10 of a laptop computer using a finger, the touch panel 10 receives touch information of the finger being a touch object through the plurality of touch electrodes 10-1 to 10-N and generates an electrical signal corresponding thereto, such that the touch sensing unit 20 receives an electrical signal through the plurality of touch sensors 20-1 to 20-N, senses a start position and time of a point touched by the finger and a touch pattern and direction thereof, and outputs an electrical signal from an electrical state variation.

In a method for sensing the start position and time of the point touched by the finger in the touch sensing unit 20, after center point coordinates of the touched point are computed by searching the entire touch region on the touch panel 10, the next touch data is received to find center point coordinates of a touched point thereof.

On the other hand, the data comparator 32 sequentially receives touch data, compares touch data currently input by the finger to touch data previously input by the finger, and computes a coordinate movement value varied on X and Y axes of the touch panel 10.

Using the coordinate movement value between the touch data currently and previously input by the finger computed in the data comparator 32, the pointer coordinate determinator 34 determines pointer coordinates on the X and Y axes of the touch panel 10 of the pointing device by initially computing a touch region of a particular position touched by the finger on the touch panel 10 of the laptop computer.

The MCU 50 computes a touch point start position, a movement direction, and a movement path of the touch finger from the pointer coordinates on the X and Y axes of the touch panel 10 output from the pointer coordinate determinator 34, stores computed values thereof, generates sensing data after combining the computed values to stabilize touch data, or generates sensing data without any touch data correction, when the touch by the person is stopped, and transfers a corresponding instruction to a host computer such that an operation indicated by an input signal applied to the touch panel 10, that is, an operation for running a corresponding program by touching an icon located in a touch region of a particular position on the touch panel 10, is performed.

However, when a plurality of objects touch the touch panel 10, the above-described touch sensor device according to the prior art synthetically recognizes according to characteristics of matrix circuitry without individually recognizing the touch objects and outputs coordinates of one position irrespective of the number of touch objects, such that there is a problem in that the plurality of touch objects may not be individually recognized at the same time.

For example, when four persons at a tablet PC are located at top, bottom, left, and right positions of the touch panel 10 and simultaneously touch the touch panel 10 with their fingers, the number of touch fingers of the persons, geometric centers of the touch fingers, and positions touched by the persons are not individually recognized and motions of the touch fingers and movement directions thereof are not individually recognized, such that it is difficult to perform user interface operations intended by the four persons.

Recently, users of portable communication devices such as mobile phones, personal digital assistants (PDA), and portable multimedia players (PMP), as well as users of laptop computers, and car navigation systems, require various forms of touch coordinate recognition functions for user interfaces including not only a function for scrolling the entire screen image in a movement direction of two fingers or zooming in or out of the screen image by adjusting an interval therebetween when the two fingers move in a state in which they have touched the touch panel 10 of the laptop computer, but also a function for performing a special operation designated according to an execution instruction preset by the user when three or more than three fingers touch the touch panel 10, and the like.

When a finger is used instead of a stylus as means for touching a touch screen, a touched area may be wide and a pointer may not be viewed since the finger covers the pointer when the pointer is displayed at the center of the touched area. For this reason, when a picture or line is drawn with the finger, a display is made using temporal or spatial interpolation on the trace of the area touched by the finger.

However, since the touch sensor device according to the prior art has a simple method using a connection of conductors conventionally configured with two layers, there is a problem in that user demands may not be satisfied due to limitations in applying various algorithms of pointer coordinate recognitions and coordinate determining methods further structurally stabilized.

### DISCLOSURE OF INVENTION

### Technical Problem

The present invention provides a touch sensor device that can identify a touch position and direction of a touch object according to a simple touch or touch strength thereof by receiving data generated by touching a touch panel and that can determine pointing coordinates of a pointing device by individually recognizing geometric information of touch objects even when there are a plurality of touch objects.

The present invention also provides a pointing coordinate determining method that can determine pointing coordinates of a pointing device using the above-mentioned touch sensor device.

### Technical Solution

According to an aspect of the present invention, there is provided a touch sensor device including: a touch panel that receives an input signal generated by touching a surface and generates a touch signal from a variation of electrostatic capacitance; a touch sensing unit that receives the touch signal, senses touch information according to a simple touch or touch strength of the touch object, and outputs an electrical signal from an electrical state variation; a touch data storage that stores touch data on a touch pattern and a touch direction of the touch object in response to the electrical signal; a template storage that prestores templates for various outlines of the touch object differing according to the touch pattern and the touch direction in response to the electrical signal; and a touch data processor that senses an outline of the touch object by receiving the touch data and selecting coordinates of previous touch data or coordinates of current touch data according to a spatial distance difference when the spatial distance difference between the previous touch data and the current touch data of the touch object is used, and determines pointer coordinates of a pointing device by receiving and mapping a stored template of the touch object.

In the touch sensor device according to the present invention, the touch data processor may sense the outline of the touch object by receiving the touch data and selecting the coordinates of the previous touch data or the coordinates of the current touch data according to a time difference when the time difference between the previous touch data and the current touch data of the touch object is used, and determine the pointer coordinates of the pointing device.

In the touch sensor device according to the present invention, the touch data processor may include: a data stabilizer that computes the spatial distance difference by sensing coordinates of a point touched by the touch object and filters noise of the touch data by comparing the spatial distance difference to a given distance value; a touch object outline sensor that receives the noise-filtered touch data and senses and computes the outline of the touch object; a template mapper that receives the stored template of the touch object and compares and maps the received stored template to the computed outline of the touch object; and a pointer coordinate determinator that determines the pointer coordinates of the pointing device by computing the touch pattern and the touch direction of the touch object from the mapped template of the outline of the touch object.

In the touch sensor device according to the present invention, the data stabilizer may compute a time difference by sensing a touch time of the touch object and filter noise of the touch data by comparing the computed time difference to a given time value.

In the touch sensor device according to the present invention, when there are a plurality of touch objects, the template storage may store templates for outlines differing according to touch patterns and touch directions of the touch objects, the touch object outline sensor may compute the outlines of the touch objects by individually recognizing a plurality of input signals of the touch objects, the template mapper may one-to-one map the templates stored in the template storage and the computed outlines of the touch objects, and the point coordinate determinator may compute the number of touch objects, geometric centers, template vertices, and touch positions according to a form of the touch input signal.

In the touch sensor device according to the present invention, each of the outlines of the touch objects may include a boundary line of a touch object corresponding to a 1-bit signal output from the touch panel according to a simple touch thereof and a contour line of the touch object corresponding to a multi-bit signal output from the touch panel according to touch strength thereof.

In the touch sensor device according to the present invention, the touch sensing unit may compute center point coordinates of a touched point by presetting coordinate values of representative touch regions among a plurality of regions to be actually touched.

In the touch sensor device according to the present invention, the coordinate values of the plurality of representative touch regions may be top-left point coordinates, bottom-right point coordinates, and center point coordinates in the outline of the touch object.

In the touch sensor device according to the present invention, the touch sensing unit may recognize a minimum coordinate value when a region actually touched by the touch object has the top-left point coordinates of the outline of the touch object, recognize a maximum coordinate value for the bottom-right point coordinates of the outline of the touch object, and compute the center point coordinates of the touched point by computing an average value of X coordinate values and an average value of Y coordinate values with respect to the top-left point coordinates and the bottom-right point coordinates on the touch panel.

In the touch sensor device according to the present invention, the coordinate values of the plurality of representative touch regions may be top-left point coordinates, top-right point coordinates, bottom-left coordinates, bottom-right coordinates, and center point coordinates of the outline of the touch object.

In the touch sensor device according to the present invention, the touch sensing unit may recognize first to fourth coordinate values when a region actually touched by the touch object has the top-left point coordinates, the top-right point coordinates, the bottom-left coordinates, and the bottom-right coordinates of the outline of the touch object, and recognize a fifth coordinate value for the center point coordinates of the outline of the touch object.

In the touch sensor device according to the present invention, the touch sensing unit may compute the center point coordinates of the touched point by deriving an X or Y coordinate of the center point coordinates from X or Y coordinates of coordinate values of representative touch regions at an edge of regular boundaries close thereto according to a position of the touched point after presetting regular top, bottom, left, and right boundaries at an edge of an entire touch panel or regular internal region.

In the touch sensor device according to the present invention, the coordinate values of the plurality of representative touch regions may be top-left point coordinates, top-right point coordinates, bottom-left coordinates, bottom-right coordinates, and center point coordinates on the touch panel.

In the touch sensor device according to the present invention, the touch sensing unit may directly maintain the X coordinate of the center point coordinates of the actually touched point and derive the Y coordinate thereof from Y coordinates of the top-left point coordinates and the top-right point coordinates when an outline of a region actually touched by the touch object is located between the top-left point coordinates and the top-right point coordinates or between the bottom-left point coordinates and the bottom-right point coordinates at the edge of the regular boundaries, and the touch sensing unit may directly maintain the Y coordinate of the center point coordinates of the actually touched point and derive the X coordinate thereof from X coordinates of the top-left point coordinates and the bottom-left point coordinates when the outline of the region actually touched by the touch object is located between the top-left point coordinates and the bottom-left point coordinates or between the top-right point coordinates and the bottom-right point coordinates at the edge of the regular boundaries.

In the touch sensor device according to the present invention, the touch sensing unit may compute electrostatic capacitance values for a plurality of coordinates of regions actually touched by the touch object on the touch panel, select a coordinate axis of a largest electrostatic capacitance value and coordinate values of more than a threshold electrostatic capacitance value, select coordinates of a point having the largest electrostatic capacitance value among the coordinate values, and determine the center point coordinates of the touched point.

In the touch sensor device according to the present invention, the touch sensing unit may determine that the touch object has not touched when the electrostatic capacitance value at the touched point on the touch panel is less than the threshold electrostatic capacitance value, and determine that the touch object has touched only when the electrostatic capacitance value is more than the threshold electrostatic capacitance value.

In the touch sensor device according to the present invention, the touch sensing unit may generate the contour line by measuring electrostatic capacitance distributions step by step with respect to the plurality of coordinates of the actually touched regions, retrieve a plurality of coordinate axes having a plurality of electrostatic capacitance values for the contour line and a plurality of coordinate values of the actually touched regions, and, after first selecting a coordinate axis having a largest electrostatic capacitance value among the plurality of coordinate axes and coordinate values of more than the threshold electrostatic capacitance value, determine the center point coordinates of the touched point by selecting point coordinates having a largest electrostatic capacitance value among the coordinate values of more than the threshold electrostatic capacitance value on the coordinate axis having the largest electrostatic capacitance value.

In the touch sensor device according to the present invention, the data stabilizer may filter noise in a space domain by maintaining the coordinates of the previous touch data if the spatial distance difference is less than the given distance value and selecting the coordinates of the current touch data if the spatial distance difference is more than the given distance value when the spatial distance difference is used, and filter noise in a time domain by maintaining a previous touch time if the time difference is less than a given time value and selecting a new touch time if the time difference is more than the given time value when the time difference is used.

In the touch sensor device according to the present invention, the touch object outline sensor may compute the boundary line of the touch object with respect to the simple touch according to an area touched by the touch object and compute the contour line of the touch object with respect to the touch strength of the touch object.

In the touch sensor device according to the present invention, when an arbitrary touch object intermittently repeats touch and non-touch operations on the same touch region in a short time in a state in which a plurality of touch objects touch the touch panel, the template mapper may select an outline of the arbitrary touch object, and compare and map the selected outline to the stored template for the outline of the touch object.

In the touch sensor device according to the present invention, the pointer coordinate determinator may compute the touch pattern and the touch direction according to a coarse level of the boundary line of the touch object when the touch signal is the 1-bit signal, and compute the touch pattern and the touch direction according to a dense level of the contour line of the touch object when the touch signal is the multi-bit signal.

The touch sensor device according to the present invention may select and execute a menu when only one object touches the touch panel, scroll an entire screen image according to movement directions of two touch objects or zoom in or out of the screen image according to interval adjustment between the two touch objects when the two touch objects touch and move on the touch panel, and perform an operation designated according to an execution instruction preset by a user when the plurality of touch objects touch the touch panel.

According to another aspect of the present invention, there is provided a pointing coordinate determination method of a touch sensor device including: a touch signal generation step of receiving an input signal generated by touching a surface of a touch panel and generating a touch signal from a variation of electrostatic capacitance; a touch sensing step of receiving the touch signal, sensing touch information according to a simple touch or touch strength of the touch object, and outputting an electrical signal from an electrical state variation; a touch data storage step of storing touch data on a touch pattern and a touch direction of the touch object in response to the electrical signal; a template storage step of prestoring templates for various outlines of the touch object differing according to the touch pattern and the touch direction in response to the electrical signal; and a touch data processing step of sensing an outline of the touch object by receiving the touch data and selecting coordinates of previous touch data or coordinates of current touch data according to a spatial distance difference when the spatial distance difference between the previous touch data and the current touch data of the touch object is used, and determining pointer coordinates of a pointing device by receiving and mapping a stored template of the touch object.

In the pointing coordinate determination method of the touch sensor device according to the present invention, the touch data processing step may include: sensing the outline of the touch object by receiving the touch data and selecting the coordinates of the previous touch data or the coordinates of the current touch data according to a time difference when the time difference between the previous touch data and the current touch data of the touch object is used; and determining the pointer coordinates of the pointing device.

In the pointing coordinate determination method of the touch sensor device according to the present invention, the touch data processing step may include: a data stabilization step of computing the spatial distance difference by sensing coordinates of a point touched by the touch object and filtering noise of the touch data by comparing the spatial distance difference to a given distance value; a touch object outline sensing step of receiving the noise-filtered touch data and sensing and computing the outline of the touch object; a template mapping step of receiving the stored template of the touch object and comparing and mapping the received stored template to the computed outline of the touch object; and a pointer coordinate determination step of determining the pointer coordinates of the pointing device by computing the touch pattern and the touch direction of the touch object from the mapped template of the outline of the touch object.

In the pointing coordinate determination method of the touch sensor device according to the present invention, the data stabilization step may include: computing a time difference by sensing a touch time of the touch object; and filtering noise of the touch data by comparing the computed time difference to a given time value.

In the pointing coordinate determination method of the touch sensor device according to the present invention, when there are a plurality of touch objects for the touch sensor device, the template storage step may store templates for outlines differing according to touch patterns and touch directions of the touch objects, the touch object outline sensing step may compute the outlines of the touch objects by individually recognizing a plurality of input signals of the touch objects, the template mapping step may one-to-one map the templates stored in the template storage and the computed outlines of the touch objects, and the point coordinate determination step may compute the number of touch objects, geometric centers, template vertices, and touch positions according to a form of the touch input signal.

In the pointing coordinate determination method of the touch sensor device according to the present invention, the touch sensing step may include: computing center point coordinates of a touched point by presetting coordinate values of representative touch regions among a plurality of regions to be actually touched.

In the pointing coordinate determination method of the touch sensor device according to the present invention, the coordinate values of the plurality of representative touch regions may be top-left point coordinates, bottom-right point coordinates, and center point coordinates in the outline of the touch object.

In the pointing coordinate determination method of the touch sensor device according to the present invention, the touch sensing step may include: recognizing a minimum coordinate value when a region actually touched by the touch object has the top-left point coordinates of the outline of the touch object; recognizing a maximum coordinate value for the bottom-right point coordinates of the outline of the touch object; and computing the center point coordinates of the touched point by computing an average value of X coordinate values and an average value of Y coordinate values with respect to the top-left point coordinates and the bottom-right point coordinates on the touch panel.

In the pointing coordinate determination method of the touch sensor device according to the present invention, the touch sensing step may include: presetting regular top, bottom, left, and right boundaries at an edge of an entire touch panel or regular internal region; and computing the center point coordinates of the touched point by deriving an X or Y coordinate of the center point coordinates from X or Y coordinates of coordinate values of representative touch regions at an edge of regular boundaries close thereto according to a position of the touched point.

In the pointing coordinate determination method of the touch sensor device according to the present invention, the coordinate values of the plurality of representative touch regions may be top-left point coordinates, top-right point coordinates, bottom-left coordinates, bottom-right coordinates, and center point coordinates on the touch panel.

In the pointing coordinate determination method of the touch sensor device according to the present invention, the touch sensing step may include: directly maintaining the X coordinate of the center point coordinates of the actually touched point and deriving the Y coordinate thereof from Y coordinates of the top-left point coordinates and the top-right point coordinates when an outline of a region actually touched by the touch object is located between the top-left point coordinates and the top-right point coordinates or between the bottom-left point coordinates and the bottom-right point coordinates at the edge of the regular boundaries; and directly maintaining the Y coordinate of the center point coordinates of the actually touched point and deriving the X coordinate thereof from X coordinates of the top-left point coordinates and the bottom-left point coordinates when the outline of the region actually touched by the touch object is located between the top-left point coordinates and the bottom-left point coordinates or between the top-right point coordinates and the bottom-right point coordinates at the edge of the regular boundaries.

In the pointing coordinate determination method of the touch sensor device according to the present invention, the touch sensing step may include: computing electrostatic capacitance values for a plurality of coordinates of regions actually touched by the touch object on the touch panel; selecting a coordinate axis of a largest electrostatic capacitance value and coordinate values of more than a threshold electrostatic capacitance value; selecting coordinates of a point having the largest electrostatic capacitance value among the coordinate values; and determining the center point coordinates of the touched point.

In the pointing coordinate determination method of the touch sensor device according to the present invention, the touch sensing step may include: determining that the touch object has not touched when the electrostatic capacitance value at the touched point on the touch panel is less than the threshold electrostatic capacitance value; and determining that the touch object has touched only when the electrostatic capacitance value is more than the threshold electrostatic capacitance value.

In the pointing coordinate determination method of the touch sensor device according to the present invention, the touch sensing step may include: generating the contour line by measuring electrostatic capacitance distributions step by step with respect to the plurality of coordinates of the actually touched regions; retrieving a plurality of coordinate axes having a plurality of electrostatic capacitance values for the contour line and a plurality of coordinate values of the actually touched regions; first selecting a coordinate axis having a largest electrostatic capacitance value among the plurality of coordinate axes and coordinate values of more than the threshold electrostatic capacitance value; and determining the center point coordinates of the touched point by selecting point coordinates having a largest electrostatic capacitance value among the coordinate values of more than the threshold electrostatic capacitance value on the coordinate axis having the largest electrostatic capacitance value.

In the pointing coordinate determination method of the touch sensor device according to the present invention, the data stabilization step may include: filtering noise in a space domain by maintaining the coordinates of the previous touch data if the spatial distance difference is less than the given distance value and selecting the coordinates of the current touch data if the spatial distance difference is more than the given distance value when the spatial distance difference is used; and filtering noise in a time domain by maintaining a previous touch time if the time difference is less than a given time value and selecting a new touch time if the time difference is more than the given time value when the time difference is used.

In the pointing coordinate determination method of the touch sensor device according to the present invention, the touch object outline sensing step may include: computing the boundary line of the touch object with respect to the simple touch according to an area touched by the touch object; and computing the contour line of the touch object with respect to the touch strength of the touch object.

In the pointing coordinate determination method of the touch sensor device according to the present invention, when an arbitrary touch object intermittently repeats touch and non-touch operations on the same touch region in a short time in a state in which a plurality of touch objects touch the touch panel, the template mapping step may include: selecting an outline of the arbitrary touch object; and comparing and mapping the selected outline to the stored template for the outline of the touch object.

In the pointing coordinate determination method of the touch sensor device according to the present invention, the pointer coordinate determination step may include: computing the touch pattern and the touch direction according to a coarse level of the boundary line of the touch object when the touch signal is the 1-bit signal; and computing the touch pattern and the touch direction according to a dense level of the contour line of the touch object when the touch signal is the multi-bit signal.

The pointing coordinate determination method of the touch sensor device according to the present invention may further include: selecting and executing a menu when only one object touches the touch panel; scrolling an entire screen image according to movement directions of two touch objects or zooming in or out of the screen image according to interval adjustment between the two touch objects when the two touch objects touch and move on the touch panel; and performing an operation designated according to an execution instruction preset by a user when the plurality of touch objects touch the touch panel.

### Advantageous Effects

A touch sensor device according to the present invention can use touch information regarding touch strength of a touch object as well as a simple touch thereof, such that a pointer coordinate recognition algorithm and coordinate determination method of further various pointing devices are possible.

In motion environments of the pointing devices, a pointer can be prevented from being shaken due to repeated vibration or noise and user interface operations intended by a plurality of users can be performed. When touch means is a finger, a pointer can move to a target region by placing the pointer at a finger end.

### BRIEF DESCRIPTION OF THE DRAWINGS

FIG. 1 is a schematic block diagram of a touch sensor device according to the prior art.

FIG. 2 is a schematic block diagram of a touch sensor device according to the present invention.

FIG. 3 is a flowchart showing an operation of the touch sensor device according to the present invention.

FIG. 4 is a diagram showing a first exemplary embodiment in which center point coordinates of a point touched by a touch object are computed in a touch sensing unit 110 of the touch sensor device according to the present invention shown in FIG. 2.

FIG. 5 is a diagram showing a second exemplary embodiment in which center point coordinates of a point touched by a touch object are computed in the touch sensing unit 110 of the touch sensor device according to the present invention shown in FIG. 2.

FIG. 6 is a diagram showing a third exemplary embodiment in which center point coordinates of a point touched by a touch object are computed in the touch sensing unit 110 of the touch sensor device according to the present invention shown in FIG. 2.

FIG. 7 is a diagram showing an exemplary embodiment in which noise is filtered in a data stabilizer 162 of the touch sensor device according to the present invention shown in FIG. 2.

FIG. 8 is a diagram for explaining an operation for identifying a position and touch direction of a touch object in a pointer coordinate determinator 168 of the touch sensor device according to the present invention shown in FIG. 2.

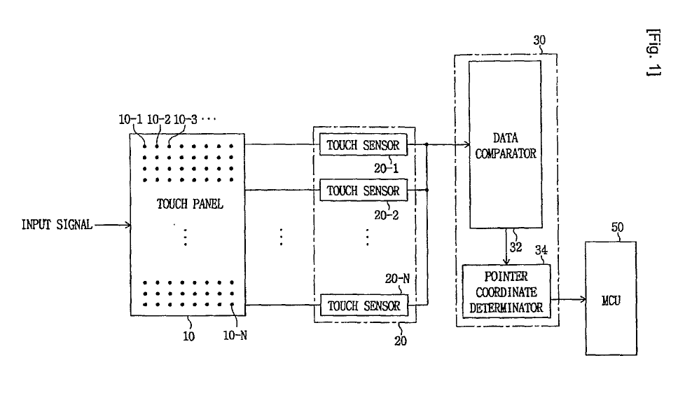

### MODE FOR THE INVENTION

Hereinafter, a touch sensor device and a pointing coordinate determination method thereof according to the present invention will be described with reference to the accompanying drawings.

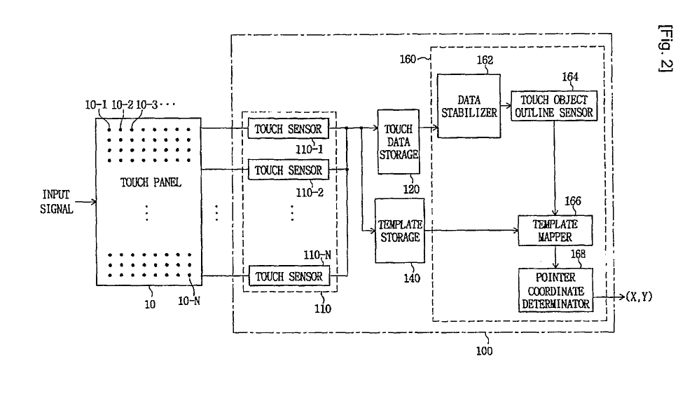

FIG. 2 is a schematic block diagram of the touch sensor device according to the present invention, which includes a touch panel 10 and a touch sensing and data processing unit 100. The touch panel 10 is configured with a plurality of touch electrodes 10-1 to 10-N, and the touch sensing and data processing unit 100 is provided with a touch sensing unit 110, a touch data storage 120, a template storage 140, and a touch data processor 160, wherein the touch data processor 160 includes a data stabilizer 162, a touch object outline sensor 164, a template mapper 166, and a pointer coordinate determinator 168.

The functions of blocks of the touch sensor device according to the present invention will be described with reference to FIG. 2.

The touch panel 10 has the plurality of touch electrodes 10-1 to 10-N in a matrix pattern on the plane, receives an input signal of a character, a number, a pattern, or the like, and generates an electrical signal from a capacitance variation.

The touch sensing unit 110 receives an electrical signal by electrically connecting a plurality of touch sensors 110-1 to 110-N to the plurality of touch electrodes 10-1 to 10-N, senses a touch point start position, a movement direction, and a movement path according to a simple touch or touch strength of a touch object, and outputs an electrical signal from an electrical state variation.

Here, the touch sensing unit 110 can be implemented with a specific shape such as a triangular or diamond shape as well as a belt shape. For convenience of explanation, an operation for sensing the electrostatic capacitance variation has been described, but electromagnetic coupling or an ultrasonic wave or infrared signal caused by the object can be sensed.

The touch data storage 120 stores touch data corresponding to the touch pattern and the touch direction of the touch object in response to the electrical signal output from the touch sensing unit 110.

The template storage 140 prestores templates for various boundary or contour lines of the touch object differing according to the touch pattern and the touch direction input to the touch panel 10.

Here, the template stored in the template storage 140 can be stored in a read only memory (ROM), externally received through a communication line (not shown), or added and updated in a self-learning method.

The data stabilizer 162 computes a spatial distance difference from previous coordinates by selecting coordinates of a touched point, computes a time difference from a previous touch time by selecting a touch time thereof, compares given values thereto, and filters noise by maintaining the previous coordinates or the previous touch time or selecting new coordinates or a new touch time.

The touch object outline sensor 164 receives the noise-filtered touch data by maintaining the previous coordinates or the previous touch time or selecting the new coordinates or the new touch time in the data stabilizer 162, and senses and computes a boundary or contour line of the touch object.

The template mapper 166 compares and maps the boundary or contour line of the touch object sensed and computed in the touch object outline sensor 164 to the template for the boundary or contour line of the touch object stored in the template storage 140.

The pointer coordinate determinator 168 determines pointer coordinates by computing a touch position using a geometric center (for example, top-left, top-right, bottom-right and center points) or a vertex of the template of the touch object from the mapped template for the boundary or contour line of the touch object.

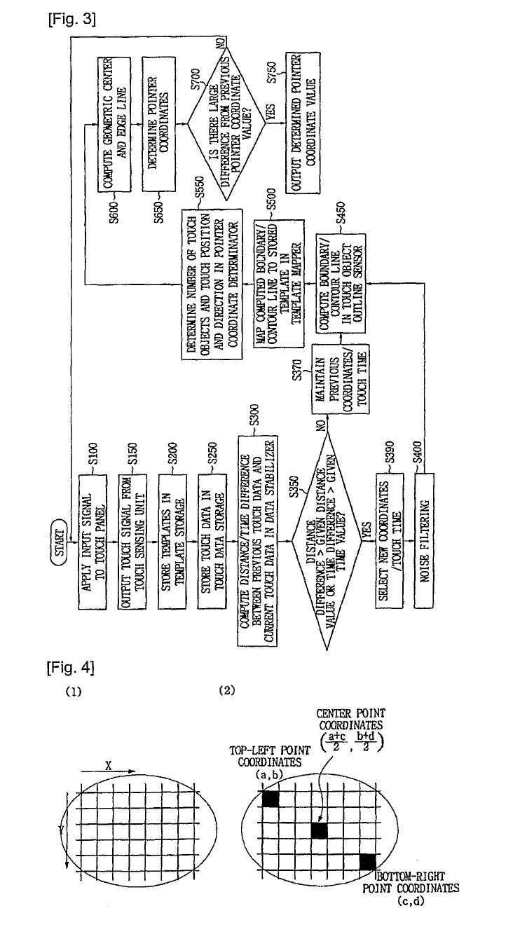

Next, FIG. 3 is a flowchart showing an operation of the touch sensor device according to the present invention, and an operation flow is as follows.

When the touch panel 10 receives an input signal of a character, a number, a pattern, or the like and generates an electrical signal from a capacitance variation (S100), the touch sensing unit 110 receives an electrical signal, senses a touch point start position, a movement direction, and a movement path according to a simple touch or touch strength of a touch object, and outputs an electrical signal from an electrical state variation (S150).

The template storage 140 prestores templates for various boundary or contour lines of the touch object differing according to a touch pattern and a touch direction input to the touch panel 10 (S200). The touch data storage 120 stores a template using touch data on the touch pattern and the touch direction of the touch object in response to the electrical signal output from the touch sensing unit 110 (S250).

The data stabilizer 162 computes a spatial distance difference from previous coordinates of previously applied and stored touch data by selecting coordinates of a touch point being the touch data currently applied from the touch data storage 120 or computes a time difference from a previous touch time of the previously applied and stored touch data by selecting a touch time of the currently applied touch data (S300), and then compares values of both the touch data (S350).

When the spatial distance difference is less than a given distance value, the previous coordinates are maintained (S370). When the spatial distance difference is more than the given distance value, new coordinates are selected (S390) and noise is filtered in a space domain (S400). When the time difference is less than a given time value, the previous touch time is maintained (S370). When the time difference is more than the given time value, a new touch time is selected (S390) and noise is filtered in a time domain (S400).

When the data stabilizer 162 outputs the touch data in which the previous coordinates or the previous touch time are/is maintained or the noise is filtered by selecting the new coordinates or the new touch time, the touch object outline sensor 164 receives the touch data, computes a boundary line of the touch object with respect to a simple touch according to an area touched thereby, and computes a contour line of the touch object with respect to touch strength thereof (S450).

The template mapper 166 compares the boundary or contour line of the touch object sensed and computed in the touch object outline sensor 164 to the template for the boundary or contour line of the touch object stored in the template storage 140, neglects a pattern of the currently sensed and computed boundary or contour line of the touch object when it is different from a pattern of the stored template, and retrieves and one-to-one maps a corresponding template when it is identical with the pattern of the stored template (S500).

The pointer coordinate determinator 168 determines a touched position and a movement direction from the one-to-one mapped template for the boundary or contour line of the touch object along with the number of touch objects (S550), and determines pointer coordinates by computing a geometric center and an edge line according to a boundary or contour line distribution of the touch object (S600, S650).

On the other hand, a value of the determined pointer coordinates is compared to a previous pointer coordinate value (S700). When a difference between the determined pointer coordinate value and the previous pointer coordinate value is large, the determined pointer coordinate value is output (S750). When the difference between the determined pointer coordinate value and the previous pointer coordinate value is small, it returns to initial step S100 to process an input signal applied to the touch panel 10.

Next, the operation of the touch sensor device according to the present invention will be described with reference to FIGS. 2 and 3.

First, the touch panel 10 generates electrical signals of a 1-bit signal output based on a simple touch of a touch object and a multi-bit signal output based on touch strength of the touch object according to a type of touch panel. In the touch sensor device according to the present invention, both the signals can be applied and operated. When multiple input signals are applied to the touch panel 10, touch data can be processed by individually recognizing the signals.

When the touch panel 10 receives touch information of the touch object through the plurality of touch electrodes 10-1 to 10-N and generates an electrical signal corresponding thereto (S100), the touch sensing unit 110 receives an electrical signal through the plurality of touch sensors 110-1 to 110-N, senses a start position and time of a point touched by the touch object, a touch pattern, and a touch direction according to a simple touch or touch capacitive strength thereof, and outputs an electrical signal from an electrical state variation (S150).

Here, in an example of measuring the touch strength of the touch object, the touch strength can be measured from a variation in a capacitance value according to a touched area or a variation in a physical interval by touch force, and can be measured using a piezoelectric material.

At this time, methods for computing center point coordinates of the touched point by sensing the start position and time of the point touched by the touch object in the touch sensing unit 110 are a method for computing and selecting 1-point coordinates among 3- or 5-point coordinates according to the user s selection by setting 3 points including a top-left point, a bottom-right point, and a center point of all regions to be actually touched on the touch panel 10 or setting 5 points including a top-left point, a top-right point, a bottom-left point, a bottom-right point, and a center point of all the regions to be actually touched, a method for intelligently mixing the 3- and 5-point coordinates according to need and situation to use the mixed coordinates, a method for deriving an X or Y coordinate of the top-left point, the top-right point, the bottom-left point, the bottom-right point, and the center point within a given boundary close to a position of a touched region after designating regular boundaries of top, bottom, left, and right edges on the touch panel 10, a method for mixing capacitive strength sensed by a touch sensor with touch data and performing a 3-dimensional recognition operation to search for center point coordinates of the touched point, and the like.

The template storage 140 prestores a template for a boundary or contour line of a touch object differing according to a finger or palm pattern and a touch direction, that is, a top-left/top-right/bottom-left/bottom-right direction, on the touch panel 100 (S200).

Here, the template for the boundary line of the touch object corresponds to a 1-bit signal output from the touch panel 10 according to the simple touch thereof and the template for the contour line of the touch object corresponds to a multi-bit signal output from the touch panel 10 according to the touch strength thereof.

The touch data storage 120 receives an electrical signal output by sensing the start position and time of the point touched by the touch object in various methods described above in the touch sensing unit 110 and stores touch data on a touch pattern and a touch direction of the touch object corresponding thereto (S250).

On the other hand, the data stabilizer 162 filters noise of the touch data stored in the touch data storage 120 in two domains, and uses a method in which a spatial distance difference from previous coordinates is computed by selecting coordinates of the point touched by the touch object on the touch panel 10 (S300), a given distance value is compared thereto, previous coordinates are maintained or new coordinates are selected, and a filtering operation is performed in a space domain and a method in which a time difference from a previous touch time is computed by selecting a time at which the touch object touches the touch panel 10 (S300), a given time value is compared thereto, a previous touch time is maintained or a new touch time is selected, and a filtering operation is performed in a time domain.

Here, the noise in the space domain appears when a fingerprint is in contact with part of a touch sensor or a signal of peripheral touch sensor components or an operation signal is coupled, and the noise in the time domain appears when a power supply voltage or an electronic wave induced on a human body due to a mobile phone is input.

That is, when the touch object touches the touch panel 10 and the touch sensing unit 110 outputs an electrical signal from an electrical state variation to the data stabilizer 162 through a sensing operation, its touch data is compared to touch data previously stored in the touch data storage 120 (S350), the noise in the time domain is recognized when a difference between both the touch data is large (S390) and a low-pass filtering operation is performed (S400). When the difference between both the data is small, the previously stored touch data is directly maintained (S370).

The touch object outline sensor 164 computes a boundary line of the touch object with respect to a simple touch of the touch object according to a touched area, computes a contour line of the touch object with respect to touch strength of the touch object, and individually computes boundary or contour lines when there are a plurality of touch objects (S450).

The template mapper 166 receives a computed boundary or contour line of at least one touch object, compares and maps the received boundary or contour line to a template for the boundary or contour line of the touch object, for example, a finger or palm pattern of a person, prestored in the template storage 140, neglects the boundary or contour line of the touch object when it is different from the finger or palm pattern, and individually retrieves and one-to-one maps a corresponding template for at least one touch object (S500).

When multiple input signals are applied to the touch panel 10, the touch sensor device according to the present invention as described above prestores templates for boundary or contour lines differing according to touch patterns and touch directions of touch objects in the template storage 140. After the touch object outline sensor 164 computes the boundary or contour lines of the touch objects by individually recognizing the input signals, the template mapper 166 processes touch data thereof by one-to-one mapping the data.

When the plurality of touch objects touch the touch panel 10, the touch data can be processed by individually identifying the number of touch objects, geometric centers, and positions according to touched input patterns and also individually recognizing motions and movement directions of the touch objects.

On the other hand, a 1-bit signal corresponding to a boundary line of a touch object according to the simple touch of the touch object may have a small template mapping error, but a multi-bit signal corresponding to a contour line of the touch object according to the touch strength of the touch object makes it possible to correctly map a template.

For example, when an arbitrary touch object other than a finger of a person touches the touch panel 10, a multi-bit signal is uniformly output. Since a contour line of the touch object is smaller than that of the finger of the person, it can be easily determined whether the touch object has touched the touch panel 10.

In the above-described exemplary embodiment, a drag operation for moving a pointer of the pointing device using a template having a large distance or time difference among matched templates after mapping and comparing a template for a boundary or contour line of a touch object in current touch to a stored template for a boundary or contour line of a touch object in previous touch and retrieving the matched templates has been described, but the case where the pointer of the pointing device performs a tapping operation by detecting a template repeatedly appearing and disappearing among previous templates of boundary or contour lines of several touch objects can also be applied to the touch sensor device of the present invention.

Here, the tapping operation of the pointer of the pointing device refers to an operation for performing the same function as an operation for clicking a left button of a general mouse when touch and non-touch operations on the same touch region are repeated in a short time in the touch panel 10.

For example, when the index finger of a person repeats touch and non-touch operations on the same touch region in a short time in a state in which his/her right palm and index finger are in contact with the touch panel 10, a tapping operation can be performed by comparing a stored template for a boundary or contour line of a touch object in previous touch to a template for the boundary or contour line of the touch object in current touch, detecting a right palm template and an index finger template, selecting only the boundary or contour line of the index finger repeating the touch and non-touch operations, and mapping the boundary or contour line of the index finger to the stored template therefor.

On the other hand, the pointer coordinate determinator 168 first checks the number of touch objects using a template one-to-one mapped to a boundary or contour line of at least one touch object, individually determines a touched position and movement direction of each touch object (S550), and determines pointer coordinates of the pointing device by independently computing a geometric center and an edge line according to the boundary or contour line of each touch object (S600, S650).

Moreover, a determined pointer coordinate value is compared with a previous pointer coordinate value (S700). When a difference between the determined pointer coordinate value and the previous pointer coordinate value is large, it means that the pointer coordinate value has been updated, such that the determined pointer coordinate value is output (S750). When the difference between the determined pointer coordinate value and the previous pointer coordinate value is small, the previous pointer coordinate value is directly maintained. Accordingly touch data is processed through the same process as that of the above steps by returning to initial step S100 and receiving the next input signal applied to the touch panel 110.

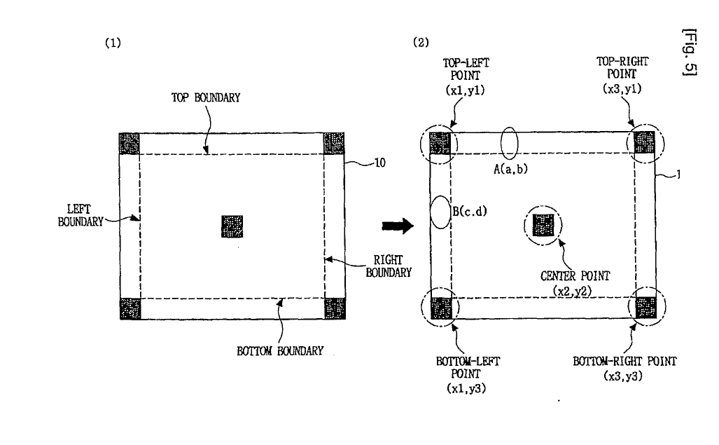

FIG. 4 is a diagram showing a first exemplary embodiment in which center point coordinates of a point touched by a touch object are computed in the touch sensing unit 110 of the touch sensor device according to the present invention shown in FIG. 2. In FIG. 4, (1) shows a plurality of touch regions of a matrix pattern to be actually touched that are searched for on the touch panel 10, and (2) shows a plurality of touch regions including reference coordinates required to compute center point coordinates of a touched point.

An operation of the first exemplary embodiment in which the touch sensing unit according to the present invention computes center point coordinates of a touched point according to a simple touch of the touch object will be described with reference to FIG. 4.

First, all regions touched on the touch panel 10 are searched for and a touch region at a most top-left position among the touched regions is recognized as a minimum value and a touch region at a most bottom-right position is recognized as a maximum value. A middle value of the touched regions is produced by computing an average value of X coordinate values and an average value of Y coordinate values between the minimum value at the most top-left position and the maximum value at the most bottom-right position.

For example, when a touch object such as a finger or palm of a person touches an arbitrary touch region on the touch panel 10, a top-left position and a bottom-right position on a closed curve of the finger or palm are recognized in the form of the closed curve according to a touch pattern and direction in regions to be actually touched, minimum and maximum values of coordinates thereof are sensed, and center point coordinates of a point touched by the finger or palm of the person are determined through the above computation process.

In the above-mentioned exemplary embodiment, reference coordinates of regions to be actually touched are set to three positions, but can extend to five positions further including a top-right position and a bottom-left position and can further include coordinates of a representative outline point. When a plurality of touch objects simultaneously touch the touch panel 10, five-reference coordinates can be intelligently mixed and used according to need and situation.

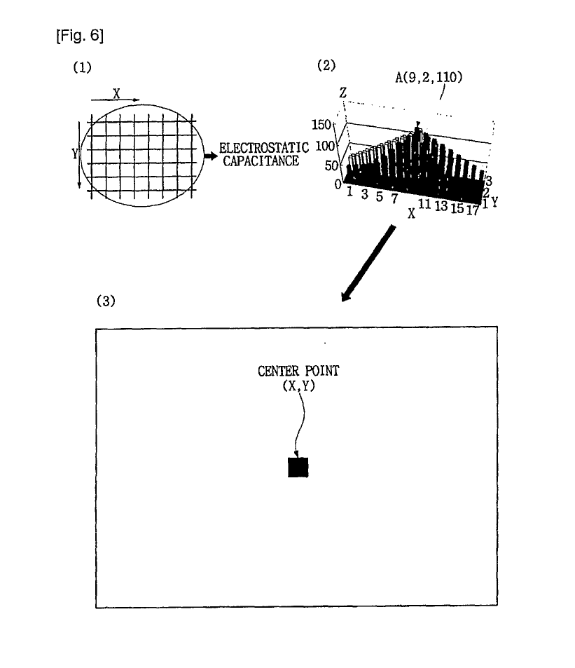

Next, FIG. 5 is a diagram showing a second exemplary embodiment in which center point coordinates of a point touched by a touch object are computed in the touch sensing unit 110 of the touch sensor device according to the present invention shown in FIG. 2. In FIG. 5, (1) shows the touch panel 10 including a predetermined boundary at top, bottom, right, and left edges, and (2) shows the touch panel 10 for deriving center point coordinates of a touched point when an actually touched region is at an edge of a predetermined boundary region.

An operation of the second exemplary embodiment in which the touch sensing unit according to the present invention computes center point coordinates of a touched point according to a simple touch of the touch object will be described with reference to FIG. 5.

First, a difference from the first exemplary embodiment in which the center point coordinates are computed according to the simple touch of the touch object as shown in FIG. 4 is that first to fifth values are recognized by setting representative coordinate values at a top-left point, a top-right point, a center point, a bottom-left point, and a bottom-right point on the touch panel 10 without sensing minimum and maximum values of coordinates of touched regions by searching for all actually touched regions, and that an X or Y coordinate of a regular boundary region close to an X or Y coordinate of center point coordinates is derived according to a position of a touched region after presetting regular top, bottom, left, and right boundaries at an edge of the touch panel 10 without individually computing for touch objects in a center point coordinate computation method.

Accordingly, when the touch object touches an arbitrary touch region on the touch panel 10, a boundary line of an actually touched region is recognized with an X or Y coordinate of the first to fifth coordinate values computed on the touch panel 10 in a closest region among positions of the top-left point, the top-right point, the center point, the bottom-left point, and the bottom-right point of the touch panel 10 according to predetermined top, bottom, left, and right boundary regions at the edge of the touch panel 10, such that center point coordinates of the point touched by the touch object are determined.

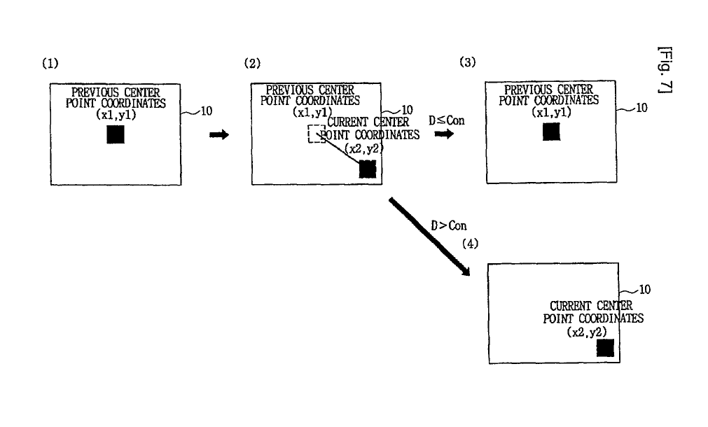

That is, when the actually touched region is located inside a predetermined boundary region, the center point coordinates of the touched region itself are computed in the same method as in the first exemplary embodiment shown in FIG. 6. However, when the actually touched region is located at the edge of the predetermined boundary region, the center point coordinates of the touched point are determined by deriving X and Y coordinates of the actually touched region from X and Y coordinates of the computed first to fifth coordinate values.

For example, when coordinates of a region actually touched by a finger of a person on the touch panel 10 are A(a, b) as shown in (2) of FIG. 5, they are located between a top-left point (x1, y1) and a top-right point (x3, y1) at the edge of a predetermined top boundary region, such that the X coordinate (a) of the center point coordinates of the actually touched region is directly maintained and the Y coordinate (b) is set to the Y coordinate (y1) of the top-left point (x1, y1) and the top-right point (x3, y1). Therefore, the center point coordinates of the touched point are set to (a, y1).

When the center point coordinates of the actually touched region are B(c, d), they are located between the top-left point (x1, y1) and the bottom-left point (x1, y3) at the edge of a predetermined left boundary region of the touch panel 10, such that the Y coordinate (d) of the center point coordinates of the actually touched region is directly maintained and the X coordinate (c) is set to the X coordinate (x1) of the top-left point (x1, y1) and the top-right point (x1, y3). Therefore, the center point coordinates of the touched point are set to (x1, d).

So far, for convenience of explanation, an edge boundary of the entire touch panel 10 has been described, but a particular portion can be set to an edge boundary by dividing the touch panel 10 into multiple portions. In particular, a particular region can be set by a graphical user interface (GUI) according to an application, and a touch region can be formed in another shape than a rectangular shape.

Next, FIG. 6 is a diagram showing a third exemplary embodiment in which center point coordinates of a point touched by a touch object are computed in the touch sensing unit 110 of the touch sensor device according to the present invention shown in FIG. 2. In FIG. 6, (1) shows a plurality of touch regions of a matrix pattern to be actually touched that are searched for on the touch panel 10, (2) shows discrete electrostatic capacitance distributions of an actually touched region measured on the touch panel 10, and (3) shows the touch panel 10 including center point coordinates of a touched point computed according to touch strength of the touch object.

An operation of the third exemplary embodiment in which the touch sensing unit according to the present invention computes center point coordinates of a touched point according to touch strength of the touch object will be described with reference to FIG. 6.

First, a difference from the first and second exemplary embodiments shown in FIGS. 4 and 5 is that center point coordinates are searched for using a contour line of a touch object according to touch strength thereof by mixing touch data with capacitive strength sensed by a touch sensor in the touch sensing unit and performing three-dimensional recognition, without using a boundary line of the touch object according to a simple touch thereof, when all regions actually touched on the touch panel 10 are searched for.

That is, when the capacitive strength sensed by the touch sensor is largest in a region touched by the touch object on the touch panel, the touch sensing unit recognizes a maximum electrostatic capacitance value. When the capacitive strength is less than a threshold electrostatic capacitance value, it is determined that no touch has been made.

For example, it is assumed that a Y axis having the maximum electrostatic capacitance value is a second Y axis on the coordinate plane and the threshold electrostatic capacitance value is 50. In this case, when a touch object such as a finger or palm of a person touches an arbitrary touch region as shown in (1) of FIG. 6 on the touch panel 10, the touch sensing unit measures discrete electrostatic capacitance distributions of the actually touched region as shown in (2) of FIG. 6 and scans a plurality of Y axes 1 to 3 having a plurality of electrostatic capacitance values for a contour line and a plurality of coordinate values of actually touched regions.

Thereafter, the second Y axis 2 being the axis having the maximum electrostatic capacitance value among the plurality of Y axes 1 to 3 is selected and coordinate values of touch regions of more than the threshold electrostatic capacitance value of 50 are first selected from among the plurality of coordinate values. Then, three-dimensional coordinates (9, 2, 110) configured with X and Y coordinates of a point A having the maximum electrostatic capacitance value of 100 and a Z coordinate of the electrostatic capacitance value is selected from among the coordinate values of the touch regions of more than the threshold electrostatic capacitance value of 50 on the second Y axis 2.

Consequently, the three-dimensional coordinates (9, 2, 110) selected as described above are set to center point coordinates of the point touched by the touch object on the touch panel 10 as shown in (3) of FIG. 6. Comparing with the previous exemplary embodiments where 1-bit boundary patterns are made with a threshold electrostatic capacitance value, the third exemplary embodiment can produce the right position when the touch sensor can detect multi-bit capacitance values.

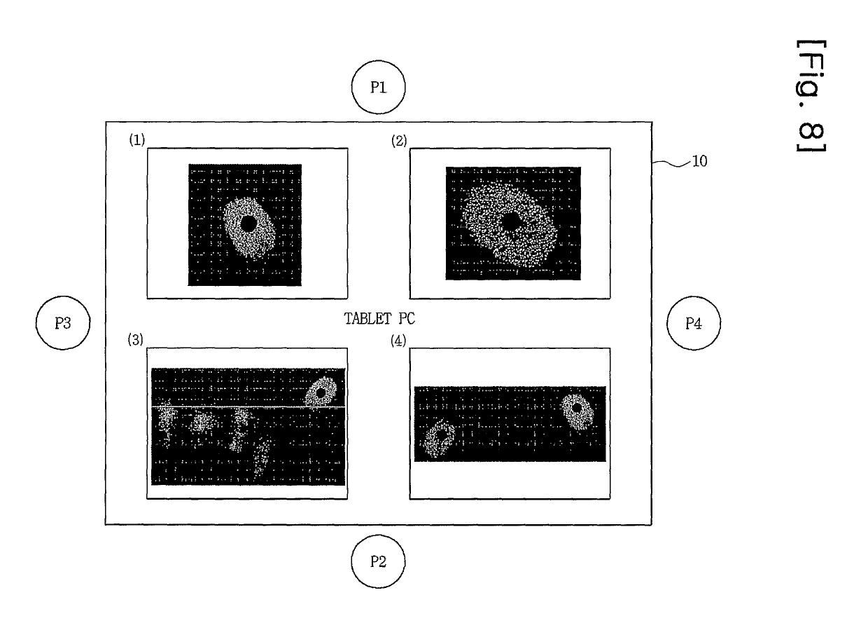

Next, FIG. 7 is a diagram showing an exemplary embodiment in which noise is filtered in the data stabilizer 162 of the touch sensor device according to the present invention shown in FIG. 2. In FIG. 2, (1) shows the touch panel 10 including center point coordinates (x1, y1) computed in previous touch, (2) shows the touch panel 10 including center point coordinates (x2, y2) computed in current touch, and (3) and (4) show the touch panel 10 including new center point coordinates computed by filtering noise.

An operation of the exemplary embodiment in which the data stabilizer 162 according to the present invention filters noise will be described with reference to FIG. 7.

In general, when a touch object such as a finger or palm of a person touches the touch panel 10, an output may be made in a state in which a fingerprint is not partially touched and a touched point may be changed due to spatial or temporal noise. For this, improvement methods are a micro filtering method, a macro filtering method, and the like.

First, the micro filtering method is a method for performing a stabilization operation by determining that all coordinates have been touched and performing a low-pass filtering operation thereon, when touch information coordinates in a two-dimensional space domain have a difference of less than a given distance, or by performing a low-pass filtering operation in a time axis for touch information coordinates in a time domain.

On the other hand, the macro filtering method is a method for performing comparison, mapping, and stabilization operations on a prestored template for a boundary or contour line of a touch object using a variation of the boundary line of the touch object according to a simple touch thereof or a variation of the contour line of the touch object according to touch strength thereof.

When a center point of the boundary line of the touch object according to a simple touch thereof is used in the micro filtering method and the macro filtering method, the center point is not varied even when the boundary line is slightly varied. When an end of a direction indicated by the touch object is used, a direction of a touch pattern is also not varied. When the variation is less than or equal to a given value, the same pointing coordinates as previous touch coordinates are maintained and output.

That is, when the touch sensing unit of the touch sensor device determines center point coordinates (x2, y2) of a newly touched point according to a simple touch or touch strength of the touch object if the touch object newly touches the touch panel 10 as shown in (2) of FIG. 7, the data stabilizer 162 computes a distance or time difference from center point coordinates (x1, y1) determined in previous touch as shown in (1).

When the distance or time difference is less than or equal to a given value Con as shown in (3), the previous center point coordinates (x1, y1) are selected. When the distance or time difference is more than the given value Con as shown in (4), the center point coordinates (x2, y2) determined in current touch are recognized as new coordinates and noise is filtered in the space or time domain.

At this time, when noise is filtered in the time domain, touch data can be stabilized through the micro and macro filtering operations after computing an average value by accumulating a plurality of frames, that is, a plurality of touch data sequentially applied from all touch pixels within the touch panel.

As described above, the touch sensor device according to the present invention outputs new coordinates if the distance or time difference is large when center point coordinates determined in current touch are compared to those determined in previous touch. When the distance or time difference is small, the pointer of the pointing device can be prevented from being shaken due to repeated vibration or noise by performing the micro and macro filtering operations.

Next, FIG. 8 is a diagram for explaining an operation for identifying a position and touch direction of a touch object in the pointer coordinate determinator 168 of the touch sensor device according to the present invention shown in FIG. 2. In FIG. 8, four persons P1 to P4 are located at a tablet PC or PC having table-sized large touch screen. In the tablet PC, input patterns 1 to 4 touched in four finger shapes on the touch panel 10 are present. Commonly, star marks indicate touch finger ends and circular marks indicate finger centers.

In FIG. 8, when the four persons P1 to P4 are located at top, bottom, left, and right positions of the touch panel 10 of the tablet PC and simultaneously touch the same touch panel 10 with their fingers, the number of touch fingers, geometric centers of the touch fingers, and touched positions are identified according to touched input patterns and then motions and movement directions of the touch fingers are identified.

That is, when an input pattern touched on the touch panel 10 has the form of (1), there is a high possibility that a touch direction is a northwest direction. The pointer coordinate determinator 168 identifies that the person P2 located at a bottom side of the tablet PC has touched the touch panel 10 with a right finger or the person P4 located at a right side of the tablet PC has touched the touch panel 10 with a left finger. On the other hand, when an input pattern touched on the touch panel 10 has the form of (2), there is a high possibility that a touch direction is a southeast direction. The pointer coordinate determinator 168 determines the pointer coordinates by identifying that the person P1 located at a top side of the tablet PC has touched the touch panel 10 with a right finger or the person P3 located at a left side of the tablet PC has touched the touch panel 10 with a left finger.

When an input pattern touched on the touch panel 10 has the form of (3), there is a high possibility that the same person touches with a plurality of fingers in a northeast direction. The pointer coordinate determinator 168 identifies that the person P2 located at the bottom side of the tablet PC has touched the touch panel 10 with a plurality of left fingers by selecting a finger center or end on the basis of an input touched in the top direction. On the other hand, when an input pattern touched on the touch panel 10 has the form of (4), a plurality of fingers touch in different directions. There is a high possibility that two persons simultaneously touch at different positions. The pointer coordinate determinator 168 first identifies a type of touch direction and then identifies touched positions and left or right fingers of the persons touching on the touch panel 10 by selecting finger centers or ends direction by direction.

At this time, it can be seen that a boundary line of a finger end is softly shown and an internal boundary line of a finger is roughly shown when input data is a 1-bit signal corresponding to a boundary line of a touch object, and a contour line of the finger end is relatively dense and an internal contour line of the finger is relatively sparse when the input data is a multi-bit signal corresponding to the contour line.

As described above, the touch sensor device can not only use a signal of a boundary line of a touch object according to a simple touch thereof, but can also use a signal of a contour line of the touch object according to touch strength thereof. The touch sensor device can use further various pointer coordinate recognition algorithms and coordinate determination methods and can simultaneously recognize a plurality of touch objects.

For example, a desired operation can be performed by directly touching a screen icon on a touch panel without using an existing key in a user interface using a touch screen in a liquid crystal display (LCD) touch panel of a bank automated teller machine (ATM), mobile phone, a PDA, an MP3 player (MP3P), a portable media player (PMP), or the like.

At this time, the same function as a simple menu selection function can be implemented using the existing key when one finger touches, but various functions can be implemented by recognizing a plurality of fingers when the fingers simultaneously touch.

That is, an icon on the touch screen can be executed when two fingers touch, the entire screen can move or scroll in a movement direction when the two fingers moves in the touch state, and a special function can be performed when three fingers touch in a state in which an execution instruction designated by the user is registered.

A user interface of various functions can be used by directly touching a monitor screen when a mouse or keyboard in a laptop computer is not used. On the touch screen of the monitor, it is possible to perform various convenient operations including an operation for simultaneously selecting and moving a plurality of icons or objects, an operation for zooming in or out of a screen image using two fingers, and the like. At the time of a map search in a car navigation system, it is possible to implement map zoom-in, zoom-out, movement, and rotation functions, a function for selecting multiple regions and viewing geographical name and distance information thereof, a favorite registration function, and a function for automatically displaying an address of a selected region or a remaining distance using a plurality of fingers.

When there are a plurality of touch objects, the touch sensor device according to the present invention can perform user interface operations intended by a plurality of users by processing touch data by individually identifying the number of touch objects, geometric centers, and positions according to touch input patterns and also independently recognizing motions and movement directions of the touch objects.

While the present invention has been shown and described with reference to certain exemplary embodiments thereof, it will be understood by those skilled in the art that various changes in form and details may be made therein without departing from the spirit and scope of the invention as defined by the appended claims.

1. A touch sensor device comprising:
a touch panel that receives an input signal generated by touching a surface and generates a touch signal from a variation of electrostatic capacitance;
a touch sensing unit that receives the touch signal, senses touch information according to a simple touch or touch strength of a touch object, and outputs an electrical signal from an electrical state variation;
a touch data storage that stores touch data on a touch pattern and a touch direction of the touch object in response to the electrical signal;
a template storage that prestores templates for various outlines of the touch object differing according to the touch pattern and the touch direction in response to the electrical signal; and
a touch data processor that senses an outline of the touch object by receiving the touch data and selecting coordinates of previous touch data or coordinates of current touch data according to a spatial distance difference when the spatial distance difference between the previous touch data and the current touch data of the touch object is used, and determines pointer coordinates of a pointing device by receiving and mapping a stored template of the touch object.

2. The touch sensor device of claim 1, wherein the touch data processor senses and computes the outline of the touch object by receiving the touch data and selecting the coordinates of the previous touch data or the coordinates of the current touch data according to a time difference when the time difference between the previous touch data and the current touch data of the touch object is used, and determines the pointer coordinates of the pointing device.

3. The touch sensor device of claim 1, wherein the touch data processor includes:
a data stabilizer that computes the spatial distance difference by sensing coordinates of a point touched by the touch object and filters noise of the touch data by comparing the spatial distance difference to a given distance value;
a touch object outline sensor that receives the noise-filtered touch data and senses and computes the outline of the touch object;
a template mapper that receives the stored template of the touch object and compares and maps the received stored template to the computed outline of the touch object; and
a pointer coordinate determinator that determines the pointer coordinates of the pointing device by computing the touch pattern and the touch direction of the touch object from the mapped template of the outline of the touch object.

4. The touch sensor device of claim 3, wherein the data stabilizer computes a time difference by sensing a touch time of the touch object and filters noise of the touch data by comparing the computed time difference to a given time value.

5. The touch sensor device of claim 4, wherein when there are a plurality of touch objects,
the template storage stores templates for outlines differing according to touch patterns and touch directions of the touch objects,
the touch object outline sensor computes the outlines of the touch objects by individually recognizing a plurality of input signals of the touch objects,
the template mapper one-to-one maps the templates stored in the template storage and the computed outlines of the touch objects, and
the point coordinate determinator computes the number of touch objects, geometric centers, template vertices, and touch positions according to a form of the touch input signal.

6. The touch sensor device of claim 5, wherein each of the outlines of the touch objects includes a boundary line of a touch object corresponding to a 1-bit signal output from the touch panel according to a simple touch thereof and a contour line of the touch object corresponding to a multi-bit signal output from the touch panel according to touch strength thereof.

7. The touch sensor device of claim 6, wherein the touch sensing unit computes center point coordinates of a touched point by presetting coordinate values of representative touch regions among a plurality of regions to be actually touched.

8. The touch sensor device of claim 7, wherein the coordinate values of the plurality of representative touch regions are top-left point coordinates, bottom-right point coordinates, center point coordinates, and representative point coordinates in the outline of the touch object, and include vertex coordinates of the outline when the touch object is a finger.

9. The touch sensor device of claim 8, wherein the touch sensing unit recognizes a minimum coordinate value when a region actually touched by the touch object has the top-left point coordinates of the outline of the touch object,
recognizes a maximum coordinate value for the bottom-right point coordinates of the outline of the touch object, and
computes the center point coordinates of the touched point by computing an average value of X coordinate values and an average value of Y coordinate values with respect to the top-left point coordinates and the bottom-right point coordinates.

10. The touch sensor device of claim 7, wherein the coordinate values of the plurality of representative touch regions are top-left point coordinates, top-right point coordinates, bottom-left coordinates, bottom-right coordinates, and center point coordinates of the outline of the touch object.

11. The touch sensor device of claim 10, wherein the touch sensing unit recognizes first to fourth coordinate values when a region actually touched by the touch object has the top-left point coordinates, the top-right point coordinates, the bottom-left coordinates, and the bottom-right coordinates of the outline of the touch object, and recognizes a fifth coordinate value for the center point coordinates of the outline of the touch object.

12. The touch sensor device of claim 6, wherein the touch sensing unit computes the center point coordinates of the touched point by deriving an X or Y coordinate of the center point coordinates from X or Y coordinates of coordinate values of representative touch regions at an edge of regular boundaries close thereto according to a position of the touched point after presetting regular top, bottom, left, and right boundaries at an edge of an entire touch panel or regular internal region.

13. The touch sensor device of claim 12, wherein the coordinate values of the plurality of representative touch regions are top-left point coordinates, top-right point coordinates, bottom-left coordinates, bottom-right coordinates, and center point coordinates on the touch panel.

14. The touch sensor device of claim 13, wherein the touch sensing unit directly maintains the X coordinate of the center point coordinates of the actually touched point and derives the Y coordinate thereof from Y coordinates of the top-left point coordinates and the top-right point coordinates when an outline of a region actually touched by the touch object is located between the top-left point coordinates and the top-right point coordinates or between the bottom-left point coordinates and the bottom-right point coordinates at the edge of the regular boundaries, and
the touch sensing unit directly maintains the Y coordinate of the center point coordinates of the actually touched point and derives the X coordinate thereof from X coordinates of the top-left point coordinates and the bottom-left point coordinates when the outline of the region actually touched by the touch object is located between the top-left point coordinates and the bottom-left point coordinates or between the top-right point coordinates and the bottom-right point coordinates at the edge of the regular boundaries.

15. The touch sensor device of claim 6, wherein the touch sensing unit computes electrostatic capacitance values for a plurality of coordinates of regions actually touched by the touch object on the touch panel, selects a coordinate axis of a largest electrostatic capacitance value and coordinate values of more than a threshold electrostatic capacitance value, selects coordinates of a point having the largest electrostatic capacitance value among the coordinate values, and determines the center point coordinates of the touched point.

16. The touch sensor device of claim 15, wherein the touch sensing unit determines that the touch object has not touched when the electrostatic capacitance value at the touched point on the touch panel is less than the threshold electrostatic capacitance value, and
determines that the touch object has touched only when the electrostatic capacitance value is more than the threshold electrostatic capacitance value.

17. The touch sensor device of claim 16, wherein the touch sensing unit generates the contour line by measuring electrostatic capacitance distributions step by step with respect to the plurality of coordinates of the actually touched regions,
retrieves a plurality of coordinate axes having a plurality of electrostatic capacitance values for the contour line and a plurality of coordinate values of the actually touched regions, and,
after first selecting a coordinate axis having a largest electrostatic capacitance value among the plurality of coordinate axes and coordinate values of more than the threshold electrostatic capacitance value,
determines the center point coordinates of the touched point by selecting point coordinates having a largest electrostatic capacitance value among the coordinate values of more than the threshold electrostatic capacitance value on the coordinate axis having the largest electrostatic capacitance value.

18. The touch sensor device of claim 17, wherein the data stabilizer filters noise in a space domain by maintaining the coordinates of the previous touch data if the spatial distance difference is less than the given distance value and selecting the coordinates of the current touch data if the spatial distance difference is more than the given distance value when the spatial distance difference is used, and filters noise in a time domain by maintaining a previous touch time if the time difference is less than a given time value and selecting a new touch time if the time difference is more than the given time value when the time difference is used.

19. The touch sensor device of claim 18, wherein the touch object outline sensor computes the boundary line of the touch object with respect to the simple touch according to an area touched by the touch object and computes the contour line of the touch object with respect to the touch strength of the touch object.

20. The touch sensor device of claim 19, wherein when an arbitrary touch object intermittently repeats touch and non-touch operations on the same touch region in a short time in a state in which a plurality of touch objects touch the touch panel, the template mapper selects an outline of the arbitrary touch object, and
compares and maps the selected outline to the stored template for the outline of the touch object.

21. The touch sensor device of claim 20, wherein the pointer coordinate determinator computes the touch pattern and the touch direction according to a coarse level of the boundary line of the touch object when the touch signal is the 1-bit signal, and
computes the touch pattern and the touch direction according to a dense level of the contour line of the touch object when the touch signal is the multi-bit signal.

22. The touch sensor device of claim 21, wherein the touch sensor device selects and executes a menu when only one object touches the touch panel,
scrolls an entire screen image according to movement directions of two touch objects or zooms in or out of the screen image according to interval adjustment between the two touch objects when the two touch objects touch and move on the touch panel, and
performs an operation designated according to an execution instruction preset by a user when the plurality of touch objects touch the touch panel.

23. A pointing coordinate determination method of a touch sensor device, comprising:
a touch signal generation step of receiving an input signal generated by touching a surface of a touch panel and generating a touch signal from a variation of electrostatic capacitance;
a touch sensing step of receiving the touch signal, sensing touch information according to a simple touch or touch strength of the touch object, and outputting an electrical signal from an electrical state variation;
a touch data storage step of storing touch data on a touch pattern and a touch direction of the touch object in response to the electrical signal;
a template storage step of prestoring templates for various outlines of the touch object differing according to the touch pattern and the touch direction in response to the electrical signal; and
a touch data processing step of sensing an outline of the touch object by receiving the touch data and selecting coordinates of previous touch data or coordinates of current touch data according to a spatial distance difference when the spatial distance difference between the previous touch data and the current touch data of the touch object is used, and determining pointer coordinates of a pointing device by receiving and mapping a stored template of the touch object.

24. The pointing coordinate determination method of claim 23, wherein the touch data processing step includes:
sensing the outline of the touch object by receiving the touch data and selecting the coordinates of the previous touch data or the coordinates of the current touch data according to a time difference when the time difference between the previous touch data and the current touch data of the touch object is used; and
determining the pointer coordinates of the pointing device.

25. The pointing coordinate determination method of claim 23, wherein the touch data processing step includes:
a data stabilization step of computing the spatial distance difference by sensing coordinates of a point touched by the touch object and filtering noise of the touch data by comparing the spatial distance difference to a given distance value;
a touch object outline sensing step of receiving the noise-filtered touch data and sensing and computing the outline of the touch object;
a template mapping step of receiving the stored template of the touch object and comparing and mapping the received stored template to the computed outline of the touch object; and
a pointer coordinate determination step of determining the pointer coordinates of the pointing device by computing the touch pattern and the touch direction of the touch object from the mapped template of the outline of the touch object.

26. The pointing coordinate determination method of claim 25, wherein the data stabilization step includes:
computing a time difference by sensing a touch time of the touch object; and
filtering noise of the touch data by comparing the computed time difference to a given time value.

27. The pointing coordinate determination method of claim 26, wherein when there are a plurality of touch objects for the touch sensor device,
the template storage step stores templates for outlines differing according to touch patterns and touch directions of the touch objects,
the touch object outline sensing step computes the outlines of the touch objects by individually recognizing a plurality of input signals of the touch objects,
the template mapping step one-to-one maps the templates stored in the template storage and the computed outlines of the touch objects, and
the point coordinate determination step computes the number of touch objects, geometric centers, template vertices, and touch positions according to a form of the touch input signal.

28. The pointing coordinate determination method of claim 27, wherein the touch sensing step includes:
computing center point coordinates of a touched point by presetting coordinate values of representative touch regions among a plurality of regions to be actually touched.

29. The pointing coordinate determination method of claim 28, wherein the coordinate values of the plurality of representative touch regions are top-left point coordinates, bottom-right point coordinates, center point coordinates, and representative point coordinates in the outline of the touch object.

30. The pointing coordinate determination method of claim 29, wherein the touch sensing step includes:
recognizing a minimum coordinate value when a region actually touched by the touch object has the top-left point coordinates of the outline of the touch object;
recognizing a maximum coordinate value for the bottom-right point coordinates of the outline of the touch object; and
computing the center point coordinates of the touched point by computing an average value of X coordinate values and an average value of Y coordinate values with respect to the top-left point coordinates and the bottom-right point coordinates.

31. The pointing coordinate determination method of claim 27, the touch sensing step includes:
presetting regular top, bottom, left, and right boundaries at an edge of an entire touch panel or regular internal region; and
computing the center point coordinates of the touched point by deriving an X or Y coordinate of the center point coordinates from X or Y coordinates of coordinate values of representative touch regions at an edge of regular boundaries close thereto according to a position of the touched point.

32. The pointing coordinate determination method of claim 31, wherein the coordinate values of the plurality of representative touch regions are top-left point coordinates, top-right point coordinates, bottom-left coordinates, bottom-right coordinates, and center point coordinates on the touch panel.

33. The pointing coordinate determination method of claim 32, wherein the touch sensing step includes:
directly maintaining the X coordinate of the center point coordinates of the actually touched point and deriving the Y coordinate thereof from Y coordinates of the top-left point coordinates and the top-right point coordinates when an outline of a region actually touched by the touch object is located between the top-left point coordinates and the top-right point coordinates or between the bottom-left point coordinates and the bottom-right point coordinates at the edge of the regular boundaries; and
directly maintaining the Y coordinate of the center point coordinates of the actually touched point and deriving the X coordinate thereof from X coordinates of the top-left point coordinates and the bottom-left point coordinates when the outline of the region actually touched by the touch object is located between the top-left point coordinates and the bottom-left point coordinates or between the top-right point coordinates and the bottom-right point coordinates at the edge of the regular boundaries.

34. The pointing coordinate determination method of claim 27, wherein the touch sensing step includes:
computing electrostatic capacitance values for a plurality of coordinates of regions actually touched by the touch object on the touch panel;
selecting a coordinate axis of a largest electrostatic capacitance value and coordinate values of more than a threshold electrostatic capacitance value;
selecting coordinates of a point having the largest electrostatic capacitance value among the coordinate values; and
determining the center point coordinates of the touched point.

35. The pointing coordinate determination method of claim 34, wherein the touch sensing step includes:
determining that the touch object has not touched when the electrostatic capacitance value at the touched point on the touch panel is less than the threshold electrostatic capacitance value; and
determining that the touch object has touched only when the electrostatic capacitance value is more than the threshold electrostatic capacitance value.

36. The pointing coordinate determination method of claim 35, wherein the touch sensing step includes:
generating the contour line by measuring electrostatic capacitance distributions step by step with respect to the plurality of coordinates of the actually touched regions;
retrieving a plurality of coordinate axes having a plurality of electrostatic capacitance values for the contour line and a plurality of coordinate values of the actually touched regions;
first selecting a coordinate axis having a largest electrostatic capacitance value among the plurality of coordinate axes and coordinate values of more than the threshold electrostatic capacitance value; and
determining the center point coordinates of the touched point by selecting point coordinates having a largest electrostatic capacitance value among the coordinate values of more than the threshold electrostatic capacitance value on the coordinate axis having the largest electrostatic capacitance value.

37. The pointing coordinate determination method of claim 36, wherein the data stabilization step includes:
filtering noise in a space domain by maintaining the coordinates of the previous touch data if the spatial distance difference is less than the given distance value and selecting the coordinates of the current touch data if the spatial distance difference is more than the given distance value when the spatial distance difference is used; and
filtering noise in a time domain by maintaining a previous touch time if the time difference is less than a given time value and selecting a new touch time if the time difference is more than the given time value when the time difference is used.

38. The pointing coordinate determination method of claim 37, wherein the touch object outline sensing step includes:
computing the boundary line of the touch object with respect to the simple touch according to an area touched by the touch object; and
computing the contour line of the touch object with respect to the touch strength of the touch object.

39. The pointing coordinate determination method of claim 38, wherein when an arbitrary touch object intermittently repeats touch and non-touch operations on the same touch region in a short time in a state in which a plurality of touch objects touch the touch panel,
the template mapping step includes:
selecting an outline of the arbitrary touch object; and
comparing and mapping the selected outline to the stored template for the outline of the touch object.

40. The pointing coordinate determination method of claim 39, wherein the pointer coordinate determination step includes:
computing the touch pattern and the touch direction according to a coarse level of the boundary line of the touch object when the touch signal is the 1-bit signal; and
computing the touch pattern and the touch direction according to a dense level of the contour line of the touch object when the touch signal is the multi-bit signal.

41. The pointing coordinate determination method of claim 40, further comprising:
selecting and executing a menu when only one object touches the touch panel;
scrolling an entire screen image according to movement directions of two touch objects or zooming in or out of the screen image according to interval adjustment between the two touch objects when the two touch objects touch and move on the touch panel; and
performing an operation designated according to an execution instruction preset by a user when the plurality of touch objects touch the touch panel.
